(19) United States
(12) Patent Application Publication
(10) Pub. No.: US 2009/0165074 A1
(43) Pub. Date: Jun. 25, 2009

(54) Multi-Address Message Addressing

(75) Inventors: Erik Elstermann, Carlsbad, CA (US); Hardys Eggum, San Diego, CA (US); Clive Holborow, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/962,996

(22) Filed: Dec. 21, 2007

(51) Int. Cl. H04N 7/16

(52) U.S. Cl. 725/144

(57) ABSTRACT

Described herein are systems and methods for dynamic management of a plurality of integrated receiver decoders (IRDs) based implicitly on the uplink's knowledge of an identity pre-assigned to each IRD. Thus, the IRD association or other IRD configurations may be maintained by a uplink controller and need not be disseminated to each IRD a priori. This eliminates the need to expend network bandwidth and extra time to send out IRD configurations to individual IRDs prior to commanding or controlling the IRDs as desired.

### BACKGROUND

Television networks often rely on cable and satellite television providers for the dissemination to customers of television programs that originate from the television networks. This helps the television networks to reach a wider audience and earn additional revenues. Examples of television networks include but are not limited to international television networks that provide television programming to television markets in different countries, national television networks such as American Broadcasting Company (ABC)®, Columbia Broadcasting System (CBS)®, National Broadcasting Company (NBC)®, and Fox® television network that provide television programming in the United States, cable television networks such as USA Network™, Entertainment and Sports Programming Network (ESPN)™, Home Box Office (HBO)®, Discovery Channel™, and Disney Channel™. In turn, cable and satellite television providers maintain broadcasting or head-end facilities with integrated receiver decoders (IRDs) therein for the reception of media feeds of programs or contents from the television networks for re-broadcasting to customers.

As understood in the art, an IRD is an electronic device used to receive the transmission of radio frequency (RF) carrier signals, such as signals of television programming from the television networks, and convert such signals into analog or digital information embedded therein. The converted analog or digital information represents, for example, the television programming intended for re-broadcasting by cable and satellite television providers to their customers. Thus, the IRD serves as an interface between a cable network or satellite dish at a customer and a broadcasting facility such as one maintained by a cable or satellite television provider.

Traditionally, IRDs are managed through individual configuration of each IRD. For example, an IRD at each broadcasting facility may be directly configured a priori, at the factory by a cable or satellite television provider or by uplink such as a television network, so as to assign or associate the IRD to a particular IRD network or group prior to a command of some action or actions, such as receiving and decoding television programming from a selected television network, to the IRD through its assigned IRD network or group. When a new action requires a re-configuration of the IRDs, such as a re-assignment of the IRDs to a different IRD group for receiving different media content or transmission from a different media content provider, each IRD must be individually reconfigured before the desired action can be performed by the IRD. Thus, the traditional IRD management method is unwieldy and slow, especially for a large IRD population (wherein each IRD must be individually re-configured) and when time-critical updates need to be provided to such a large IRD population.

### SUMMARY

Described herein are systems and methods for dynamic management of a plurality of integrated receiver decoders (IRDs) based implicitly on the uplink's knowledge of an identity pre-assigned to each IRD. In various embodiments described herein, a new message preamble is employed by a uplink controller, such as a Broadcast Network Controller (BNC), to command multiple IRDs to simultaneously execute a common action. Thus, the IRD association or other IRD configurations may be maintained by a uplink controller and need not be disseminated to each IRD a priori.

Accordingly, in one embodiment there is provided a media content distribution network comprising: a media content provider that operates to provide media content; a plurality of content distribution sites that operate to receive the media content from the media content provider and to distribute the media content to a plurality of subscribers; and a plurality of decoding devices, with at least one decoding device at each of the plurality of content distribution sites, that are operable to be configured and commanded by the media content provider to perform one or more actions; wherein the media content provider further operates to provide a command message to the plurality of decoding devices at the content distribution sites, and the command message includes a selection of at least one of the plurality of decoding devices to process the command message and an action for the selected at least one decoding device to process and perform.

In another embodiment there is provided a method for managing a plurality of decoding devices to provide media content to the plurality of decoding devices, comprising: assigning an address identification (ID) to each of the plurality of decoding devices; providing the address IDs to the plurality of decoding devices; and providing a command message to the plurality of decoding devices that includes a bitmask portion identifying a selection of at least one of the plurality of decoding devices based on the assigned address IDs and a command portion identifying an action for the selected at least one decoding device to perform so as to receive the media content.

In still another embodiment, there is provided a method for receiving a command message to download media content, comprising: receiving an assignment of an address identification (ID); receiving a command message that includes a bitmask portion identifying one or more assigned address IDs and a command portion identifying an action to perform so as to receive the media content; comparing the bitmask portion with the assigned address ID as received; and upon a match between the bitmask portion with the assigned address ID as received, performing the action identified in the command portion of the command message.

### BRIEF DESCRIPTION OF THE DRAWINGS

Embodiments are illustrated by way of example and not limited in the following figure(s), in which like numerals indicate like elements, in which:

FIG. 1 illustrates an example of a conventional media content distribution network, to which various embodiments described herein may be implemented.

FIG. 2 illustrates an example of conventional process for managing integrated receiver decoders (IRDs).

FIG. 3 illustrates a process for dynamic IRD management, in accordance with one embodiment.

FIG. 4 illustrates a process for dynamic IRD management, in accordance with another embodiment.

FIG. 5 illustrates an example for dynamically managing IRDs by assigning IRDs to unique groups, in accordance with one embodiment.

FIG. 6 illustrates an example of a makeup of each command message, in accordance with one embodiment.

FIG. 7 illustrates an example of a format for a bitmask portion in a command message, in accordance with one embodiment.

FIGS. 8A-B illustrates examples of a lossless encoding scheme that may be used to encode the bitmask portion in a command message, in accordance with one embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

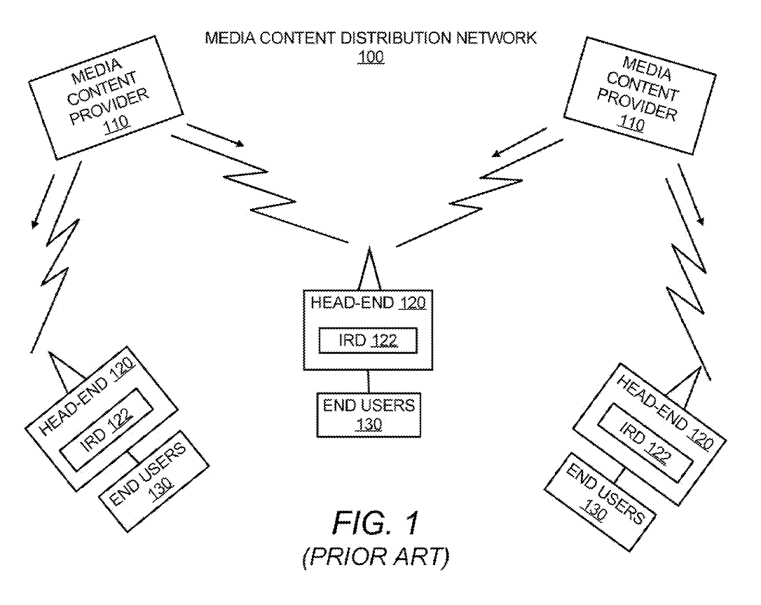

FIG. 1 illustrates an example of a conventional media content distribution network 100 that includes a plurality of media content providers 110, a plurality of head-end facilities 120, and a plurality of end users 130. The media content providers 110 are entities that provide media content. An example of a media content provider is any of the television networks noted earlier. As referred herein, media content includes audio and/or video content such as music, television programs, movies, video on demands, and pay-per-views. Media content also may include computer readable files such as textual and/or image files that include word processing or spreadsheet documents and pictures or other files that are executable by a computer or an electronic processing unit. The head-end facilities 120 are multimedia facilities maintained by service operators such as cable and satellite television providers to receive media content streams from the media content providers 110 and re-broadcast or transmit the media content streams to end-users or subscribers 130. Thus, the head-end facilities serve as content distribution sites. The end users 130 are subscribers to the media content, such as cable or satellite television subscribers.

The media content providers 110 may transmit media content streams to the head-end facilities 120 through a wired network such as a terrestrial landline network or a wireless network such as a satellite network. Each head-end facility 120 includes one or more integrated receiver decoders (IRDs) 122 for controlling and authorizing the reception of the media content streams from the media content providers 110. For example, an IRD may be configured or otherwise managed by a uplink controller in the media content provider 110 to receive and process certain types of media content for re-transmission and to blackout other types of media content to prevent the media content from being received and/or re-transmitted by a service operator's network to its end users or subscribers 110, such as cable or satellite television subscribers. Thus, the IRDs provide a media content provider with the granularity necessary to authorize access to its media content at each head-end facility.

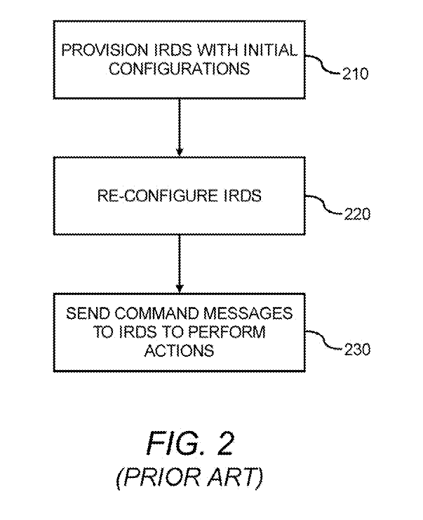

FIG. 2 illustrates an example of a process 200 for conventional management of an IRD to perform one or more actions. This process is discussed in the context of FIG. 1.

At 210, the IRDs 122 are initially provisioned with attributes such as IRD name, access control tier assignments, group assignments, and singlecast or multicast address assignments for IRD identification and configuration as understood in the art. Each IRD may be assigned a unique address, or multiple IRDs may be assigned a common address that is unique from other IRDs. This provisioning may be performed at the factory, prior to deployment in the head-end facilities 120, or via routine entitlements, e.g., authorization messages sent from a uplink controller in a media content provider 110 subsequent to deployment in the head-end facilities 120. For example, the IRDs 122 may be pre-assigned with a first geographic ID code to receive and re-broadcast media content to end users 130 from a first one of two media content providers 110 illustrated in FIG. 1, via a first communication channel between the first media content provider and the IRDs 122.

At 220, a second one of two media content providers 110 illustrated in FIG. 1 also desires the IRDs 122 to receive and process its media content for dissemination to the end users 130. For example, the second media content provider 110 may have contracted with the service operator(s) that maintains the head-end facilities to receive and re-broadcast its media content to the end users 130. However, because the IRDs 122 are initially configured to belong to the first IRD group to receive media content only from the first media content provider, they have to be re-configured to replace their first geographic ID code with a second geographic ID code in order to start receiving and disseminating media content from the second uplink or media content provider, via a second different communication channel between the second media content provider and the IRDs 122. Thus, this re-configuration also prevents the IRDs 122 from receiving and disseminating media content from the first media content provider. This re-configuration may be performed by the second media content provider via routine entitlements or authorization messages sent to the IRDs 122.

At 230, once the second media content provider directs the IRDs 122 to perform the required re-configuration, it is able to send command messages to the IRDs 122 to perform one or more action(s), such as receiving and disseminating media content from the second media content provider to the end users 130.

As illustrated in FIG. 2, the traditional IRD management method is unwieldy and slow. When there is a large IRD population, each IRD must be individually configured, for example, by explicitly assigning them to an IRD network or group prior to commanding some action or actions for each group of IRDs. Furthermore, when time-critical updates or actions need to be provided to the IRDs 122, those updates cannot be performed immediately because they may first require an IRD reconfiguration step as discussed at 220.

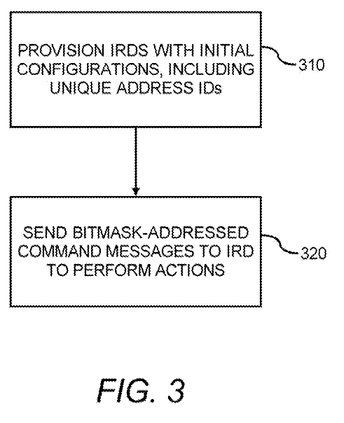

FIG. 3 illustrates a process 300 for dynamic IRD management without the potential need to reconfigure an IRD when it is commanded with a new action, in accordance with one embodiment. Thus, this process saves time by not requiring an additional IRD reconfiguration step, as required in a conventional IRD management process. Furthermore, it saves network bandwidth and, consequently, operational cost because authorization messages for IRD reconfiguration need not be sent. For illustrative purposes only and not to be limiting thereof, the process 300 is discussed in the context of FIG. 1. Also for illustrative purposes only, IRDs 122 are used to describe various embodiments herein. However, it should be understood that each IRD may be replaced with any device capable of receiving electronic signals, such as radio frequency signals, through one or more communication channels and decoding or converting such signals into information, such media content, transmitted in the electronic signals. Thus, an IRD may include a tuner for tuning to various communication channels, a modem for modulating and demodulating electronic signals, and a decrypter or decoder to decode or unscramble demodulated signals to obtain information therein.

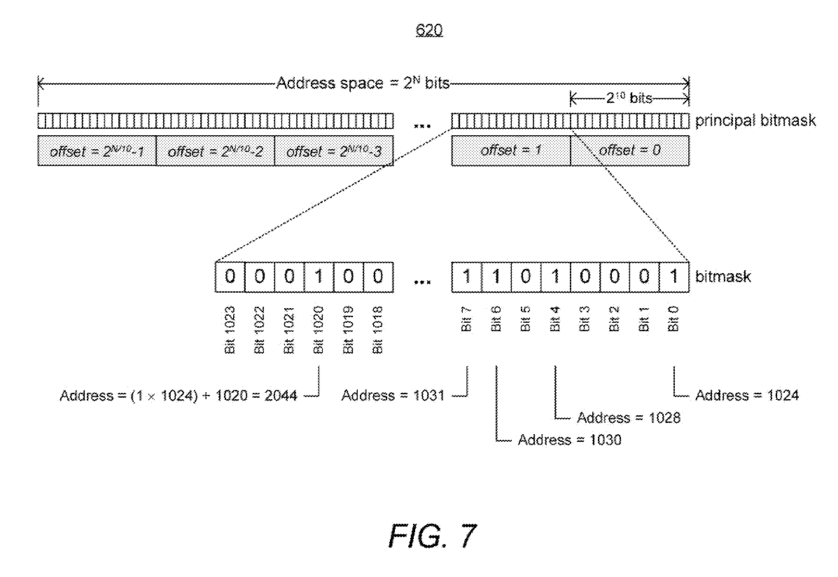

At 310, the IRDs 122 are initially provisioned with attributes such as IRD name, access control tier assignments, and singlecast or multicast address assignments for IRD identification and configuration as understood in the art. Each IRD 122 may be assigned a unique address, or multiple IRDs 122 may be assigned a common address that is unique from other IRDs 122. This provisioning may be performed at the factory or via routine entitlements, e.g., authorization messages sent from a uplink controller in the media content provider 110. The unique singlecast or multicast address assigned to each IRD provides the IRD with a unique ID that is used in a new multi-address message format for a uplink such as a media data provider 110 to send command messages to IRDs 122 with requiring the uplink to first reconfigure the IRDs 122. This multi-address message format includes a bitmask portion in each command message sent to the IRDs 122 that allows the uplink controller to direct or command any dynamic group of IRDs to perform the same action(s). Thus, the multi-address message format is also referred herein as a bitmask-addressed message format and described further later with reference to FIG. 7.

At 320, once the IRDs 122 provisioned, they may be arbitrarily grouped to perform group actions by the uplink's transmission of bitmask-addressed command messages to the IRDs 122 without requiring the re-configuration step 220 that is necessary for conventional IRD management.

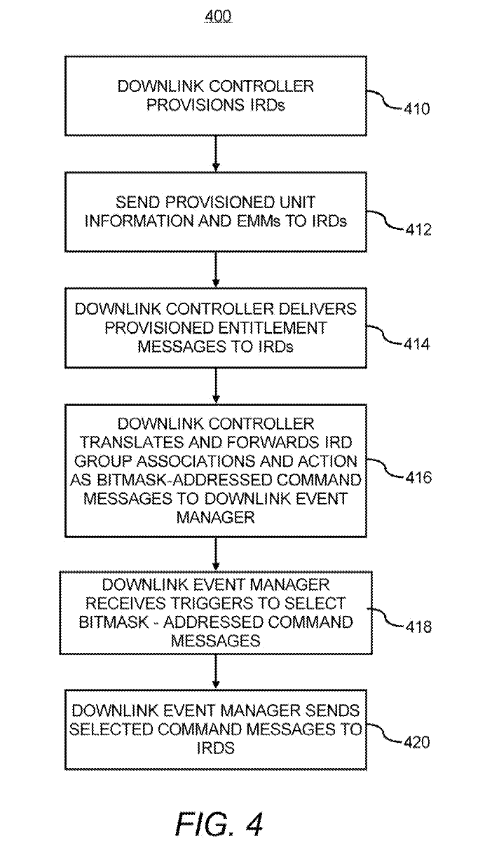

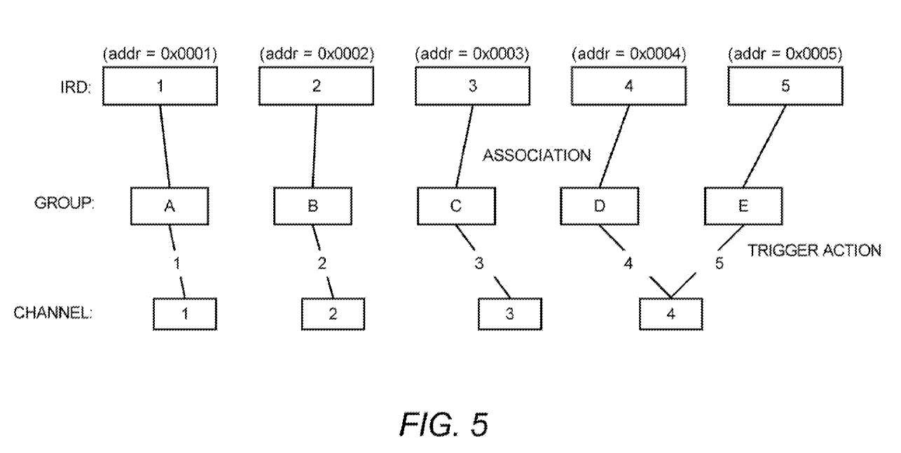

FIG. 4 illustrates a process 400 implemented by a uplink controller, such as one by a media content provider, for administering IRDs to provide dynamic IRD management, in accordance with another embodiment. Again, for illustrative purposes only and not to be limiting thereof, the process 400 is discussed in the context of FIG. 1. Also, for exemplary purposes only and not to be limiting thereof, the process 400 is discussed with a scenario illustrated in FIG. 5.

At 410, the uplink controller executes a software application, program, or module to provision the IRDs 122 with various attributes as described above at 310. The software application may be executed in a computer, or any other suitable processing machine with a processing unit therein for executing instruction code in the software application. A uplink operator may access the uplink controller via the controller's graphical user interface (GUI) and/or application programming interface (API).

At 412, the provisioned unit information and entitlement management messages are delivered to the IRDs 122 via routine entitlement or authorization messages.

At 414, IRD associations in IRD groups and possible future actions for each group may be specified in the uplink controller, for example, by a uplink operator via the controller's GUI or API. For example, as illustrated in FIG. 5, five IRDs 1-5 are being dynamically managed by the uplink controller, which specifies that each IRD is to be associated with a unique group, that is, IRD 1 is to be associated with Group A, IRD 2 is to be associated with Group B, IRD 3 is to be associated with Group C, IRD 4 is to be associated with Group D, and IRD 5 is to be associated with Group E.

At 416, the uplink controller translates the IRD associations and actions into a set of pre-computed bitmask-addressed command messages for controlling the IRDs 122. These command messages are forwarded to another software application, program, or module in the uplink, which is referred hereinafter as an event manager. The event manager is operable to send specific command messages to the IRDs 122 based on its input trigger conditions or actions, which may be provided by the uplink operator through a GUI or API provided for the event manager. Referring to the example illustrated in FIG. 5, the event manager may receive 1 of 5 trigger actions or conditions. Trigger 1 specifies that those IRDs in Group A are to process channel 1, such as decrypting and decoding content associated with channel 1. Trigger 2 specifies that those IRDs in Group B are to process channel 2. Trigger 3 specifies that those IRDs in Group C are to process channel 3. Trigger 4 specifies that those IRDs in Group D are to process channel 4. Trigger 5 specifies that those IRDs in Group E are to process channel 4.

At 418, the event manager receives one or more input triggers, such as 1 of 5 available triggers as illustrated in FIG. 5.

At 420, the event manager selects one or more command messages, as translated by the uplink controller, having value corresponding with the input trigger(s) and forwards such command messages to the IRDs 122, whereupon each IRD processes the bitmask portion in the command messages to determine whether it should obey or ignore the command. For example, as illustrated in FIG. 5, if the input trigger at the event manager is trigger 1, the event manager selects an already translated command message in the bitmask-addressed format that has a bitmask portion to specify those IRDs in Group A to process Channel 1.

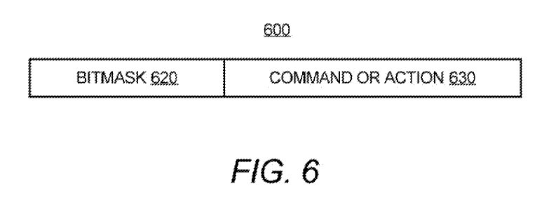

FIG. 6 illustrates an example of the makeup of each command message 600 translated by the uplink controller. The command message includes a bitmask 620 of a predetermined bit size to identify one or more IRDs that are to obey this command message, and a command or action portion 630 of a predetermined bit size that specifies the actual command or action to be carried by the identified IRDs. For example, the command portion 630 specifies that those IRDs identified in the bitmask portion 620 are to tune to channel 1 to communicate with and receive media content from the uplink.

FIG. 7 illustrates an example of a format for the bitmask portion 620 shown in FIG. 6. For an IRD identified by a unique N-bit address ID, the bitmask portion 620 represents any one of 2^{N} possible permutations for identifying the IRD, wherein N is an integer with N≧1. For example, the IRD may have an assigned multicast address where N=16. Each position in the bitmask 620 corresponds to a specific IRD address. For example, position 0 in the bitmask 620 corresponds to an IRD having an assigned address 0, position 1 in the bitmask 620 corresponds to an IRD having an assigned address 1, and so on. In general, position k in the bitmask 620 corresponds to an IRD having an assigned address k. Accordingly, each bit value in the bitmask 620 specifies whether the corresponding IRD must discard or process the command message 600.

There are instances where each IRD is assigned a unique unit address that may be quite large. In one example, an IRD may be assigned a singlecast unit address of 240 bits for security purposes. In another example, referring back to FIG. 1, in a media content distribution network 100 that involves the use of many IRDs, such as one with many head-end facilities 120 with one or more IRDs therein, each IRD may be assigned a singlecast unit address of 240 bits to ensure that each IRD is uniquely addressed. Correspondingly, bitmask-addressed messages 600 that are sent to these IRDs would become quite large in size because it would include a large bit mask portion 620 of 2⁴⁰ or 1,099,511,627,776 bits. This, in turn, would increase the bandwidth requirement for transmitting command messages 500 throughout a media content distribution network and drive up the transmission cost.

To limit the size of each bitmask-addressed message 600, a principal 2^{N} bitmask may be partitioned into smaller, subordinate bitmasks. Each subordinate bitmask conveys the message processing rules (e.g., discard or process) for up to K unique IRD addresses, where K is (last_address−base_address)+1. For example, a principle 2^{N}=2⁴⁰ bitmask may be partitioned into 4 subordinate 2¹⁰ bitmasks, each conveying the message processing rules (e.g., discard or process) for up to 2ⁿ=2¹⁰ or 1024 unique IRD addresses. Therefore, in this embodiment, each bitmask-addressed message 600 also conveys a base address and last address that is associated with the subordinate bitmask 620.

The IRD address is then computed as follows:

IRD Address=(base_address)+bit_position,

wherein the base_address variable represents the first address of the 2ⁿ-bit subordinate bitmask, and the variable bit_position represents the bit position in a corresponding 2ⁿ-bit subordinate bitmask. For example, referring to FIG. 7, a 2^{N}-bit principle bitmask may be partitioned into subordinate bitmasks, each having 2ⁿ=2¹⁰ bits. The first subordinate bitmask has a corresponding base address of 0, the second subordinate bitmask has a corresponding base address of 1024, the third subordinate bitmask has a corresponding base address of 2048, and so on to the last subordinate bitmask. Thus, for example, each IRD address in the second subordinate bitmask with a base address of 1024 is calculated as (1024)+bit_position or,

base_address 1024, position 0=IRD address 1024,

base_address 1024, position 1=IRD address 1025,

base_address 1024, position 1023=IRD address 2047.

In the example illustrated in FIG. 7, IRDs with assigned addresses 1024, 1028, 1030, 1031, and 2044 have bit value equal to 1 to indicate their selection to process the bitmask-address command message 600. Thus, they are to process the bitmask-addressed message 600 that includes this subordinate bitmask in the bitmask portion 620 (and a base address of 1024).

Depending on the density or sparseness of a principal bitmask, or partition thereof, that is used in each command message 600, the bitmask portion 620 of each command message 620 may be compressed using a lossless encoding scheme to reduce the overall message size and lower the message bit rate requirement for bandwidth reduction. For example, a byte-based, run-length encoding scheme or technique may be employed, wherein four or more consecutively repeated bytes (i.e., 32 or more bits, in multiples of 8) may be replaced by a three-byte sequence:

Escape|Count|Repeat Value.

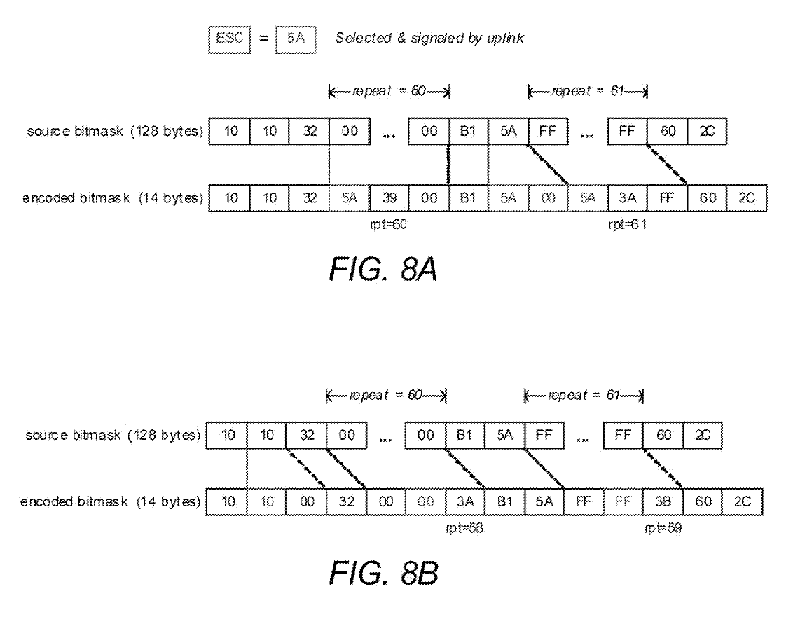

The “Escape” byte represents a predetermined or set value that indicates the start of the encoded three-byte sequence. The “Count” value represents the number of repeats (minus three). The “Repeat Value” represents the repeated byte value (if Count>0). In one embodiment, the “Escape” value is set by the uplink to be different from any byte value (i.e., 8-bit value) found in the source bitmask so as to distinguish the three-byte sequence from the rest of the values in the bitmask. Otherwise, if the “Escape” value occurs in the source bitmask, a “Count” value of zero may be used to indicate such an occurrence. FIG. 8A illustrates the aforementioned lossless encoding technique, wherein the source bitmask includes 128 bytes (or 1024 bits). In this example, each byte has a hexadecimal value to represent the values of the binary bits in each byte. As illustrated, 60 consecutively repeated bytes of a repeated value of “00” is replaced with a three-byte sequence of 5A|39|00, where “5A” is the “Escape” value set by the uplink controller. Likewise, 61 consecutively repeated bytes of a repeated value of FF is replaced with a three-byte sequence of 5A|3A|FF. As also illustrated, the value of “5A” occurs in the source bitmask. Thus, a “Count” byte of value “00” (zero) is added to indicate such an occurrence. Consequently, a source bitmask of 128 bytes is reduced to a lossless encoded bitmask of 14 bytes.

FIG. 8B illustrates an example of another lossless encoding technique, wherein the three-byte sequence does not use an “Escape” value to signal repetition. Instead, repetition is signaled by the presence of two consecutive equivalent bytes, with the following third byte having a “Count” value to represent the number of subsequent repeats. This technique yields an additional byte for each isolated byte pair. Thus, the uplink controller may determine the most efficient run-length encoding scheme or technique on a case-by-case basis and signal its selection to the IRD for proper decoding. Although several particular lossless encoding techniques are described above, it should be understood that other lossless encoding schemes may be employed here as well.

Accordingly, once each IRD in a media content distribution network is assigned a particular unique unit address, the uplink may govern the behavior of individual IRDs simply by managing the bitmask portion 620 in bitmask-addressed command messages 600 sent out to all IRDs. That is, rather than having to re-assign or reconfigure each IRD with dedicated configuration message for each IRD prior to sending out command messages to the IRDs, a uplink controller may simply adjust the bitmask delivered with each uplink command message. This allows a media content distribution network to react quickly to dynamic, “last minute” IRD configurations without using up additional bandwidth for pre-transmission of dedicated configuration messages to individual IRDs, especially when large groups of IRDs must be administered in the network.

What has been described and illustrated herein are various embodiments along with some of their variations. The terms, descriptions and figures used herein are set forth by way of illustration only and are not meant as limitations. Those skilled in the art will recognize that many variations are possible within the spirit and scope of the subject matter, which is intended to be defined by the following claims, and their equivalents, in which all terms are meant in their broadest reasonable sense unless otherwise indicated.

What is claimed is:

1. A media content distribution network for receiving media content from a media content provider, the network comprising:
a plurality of content distribution sites that operate to receive media content and to distribute the media content to a plurality of subscribers; and
a plurality of decoding devices, with at least one decoding device at each of the plurality of content distribution sites, that are operable to be configured and commanded by the media content provider to perform one or more actions;
wherein the plurality of decoding devices at the content distribution sites operate to receive a command message, and the command message includes a selection of at least one of the plurality of decoding devices to process the command message and an action for the selected at least one decoding device to process and perform.

2. The media content distribution network of claim 1, wherein the command message includes a bitmask portion that identifies the selection of the at least one decoding device and a command portion that identifies the action for the selected at least one decoding device to process and perform.

3. The media content distribution network of claim 1, wherein the action for the selected at least one decoding device includes a command to the selected at least one decoding device to tune to a predetermined communication channel to receive the media content.

4. The media content distribution network of claim 2, wherein:
each of the plurality of decoding devices is assigned an address identification (ID); and
a size of the bitmask portion of the command message is based on a size of the assigned address ID of each of the plurality of decoding devices.

5. The media content distribution network of claim 4, wherein the address ID assigned to each of the plurality of decoding devices is unique.

6. The media content distribution network of claim 4, wherein the address IDs assigned to at least some of the plurality of decoding devices are the same.

7. The media content distribution network of claim 4, wherein:
the address ID assigned to each of the plurality of decoding devices includes N bits, where N is an integer with N≧1; and
the bitmask portion of the command message includes 2^{N} bits.

8. The media content distribution network of claim 7, wherein each of the 2^{N} bits in the bitmask portion corresponds with an address ID assigned to one of the plurality of decoding devices.

9. The media content distribution network of claim 7, wherein the media content provider indicates the selection of the at least one decoding device in the command message by assigning a predetermined bit value to the bit in the bitmask portion that corresponds with the address ID of the selected at least one decoding device.

10. A method for managing a plurality of decoding devices to provide media content to the plurality of decoding devices, comprising:
assigning an address identification (ID) to each of the plurality of decoding devices;
providing the address IDs to the plurality of decoding devices; and
providing a command message to the plurality of decoding devices that includes a bitmask portion identifying a selection of at least one of the plurality of decoding devices based on the assigned address IDs and a command portion identifying an action for the selected at least one decoding device to perform so as to receive the media content.

11. The method of claim 10, further comprising:
translating the assigned action and an identification of the selected at least one decoding device into bitmask portion and the command portion of the command message, respectively;

12. The method of claim 11, wherein the media content is provided by the media content provider which also transmits the command message to the plurality of decoding devices at the content distribution sites.

13. The method of claim 12, further comprising:
receiving a trigger to send the command message to the plurality of decoding devices; wherein
the step of providing the command message further comprises providing the command message to the plurality of decoding devices upon a match between the retrieved trigger and pre-established conditions for transmission of the command message.

14. The method of claim 1, wherein:
the step of assigning the address ID to each of the plurality of decoding devices further comprises assigning an address ID having N bits to each of the plurality of decoding devices, where N is an integer with N≧1; and
the step of providing the command message further comprises providing the bitmask portion of a size based on the N-bit size of the assigned address ID of each of the plurality of decoding devices.

15. The method of claim 14, wherein the step of providing the bitmask portion further comprises:
providing the bitmask portion having 2^{N} bits.

16. The method of claim 14, wherein the step of providing the bitmask portion further comprises:
providing a principal bitmask having a size of 2^{N} bits;
partitioning the principal bitmask into multiple partitions of equal size; and
providing the bitmask portion in the command message as one of the multiple partitions of the principal bitmask.

17. The method of claim 16, wherein the step of providing the command message to the plurality of decoding devices further comprises:
providing base address and last address portions in the command message to indicate which one of the multiple partitions in the principal bitmask is used to provide the bitmask portion in the command message.

18. A method for receiving a command message to download media content, comprising:
receiving an assignment of an address identification (ID);
receiving a command message that includes a bitmask portion identifying one or more assigned address IDs and a command portion identifying an action to perform so as to receive the media content;
comparing the bitmask portion with the assigned address ID as received; and
upon a match between the bitmask portion with the assigned address ID as received, performing the action identified in the command portion of the command message.

19. The method of claim 18, wherein:
the step of receiving the assignment of the address ID includes receiving the assigned address ID having N bits, where N is an integer with N≧1; and
the step of receiving the command message further comprises receiving the bitmask portion having 2^{N} bits in the command message.

20. The method of claim 19, wherein the step of comparing the bitmask portion with the assigned address ID comprises:
identifying at least one position in the 2^{N} bits of the bitmask portion that has a predetermined value;
converting the at least one position having the predetermined value into an address ID; and
comparing the converted address ID with the address ID as assigned to determine a match.
